(19) United States
(12) Patent Application Publication
(10) Pub. No.: US 2004/0254819 A1
(43) Pub. Date: Dec. 16, 2004

(54) System and method for providing automatic and continuous price monitoring services for optimizing contract selection and replacement

(75) Inventors: Nagui Halim, Yorktown Heights, NY (US); Kun-Lung Wu, Yorktown Heights, NY (US); Philip Shi-Lung Yu, Chappaqua, NY (US)

Correspondence Address: F. CHAU & ASSOCIATES, LLP, Suite 501, 1900 Hempstead Turnpike, East Meadow, NY, 11554, US

(73) Assignee: International Business Machines Corporation, Armonk, NY

(21) Appl. No.: 10/462,528

(22) Filed: Jun. 16, 2003

(51) Int. Cl. G06F 17/60

(52) U.S. Cl. 705/5

(57) ABSTRACT

A computer implemented method of selecting replacement contracts, comprises determining consumer specifications for an existing contract, monitoring a service provider maintaining specifications of a contract offer, and monitoring the specifications of the contract offer. The method further comprises identifying the contract offer as a replacement contract for the existing contract, and notifying a consumer of an identified replacement contract.

### BACKGROUND OF THE INVENTION

1. Field of the Invention

The present invention relates to monitoring services, and more particularly to a system and method for monitoring prices for goods and services advertised on a network.

2. Discussion of Related Art

Many transactions include contracts that specify terms of the transaction, such as prices for products or services. The terms are typically fixed upon the acceptance by an obligor of the terms offered by an obligee. If a contract is canceled or breached before performance is required of the obligor, a penalty clause may specify a remedy for the contract holder or obligee. For example, once a travel itinerary is committed, the airline fare, the hotel costs and other costs are fixed for the trip. Mortgage interest rates are typically fixed for a term once the mortgage is committed. The interest rate for a certificate of deposit (CD) is also fixed for the term of the CD, such as one year or 5 years.

However, the market prices of products and services can change after contracts are executed but before the terms of the contract are to be performed. If prices or interest rates drop substantially, it may be more beneficial to replace an existing contract with a new one, even after paying any penalty for breaching the existing contract. On the other hand, for an offer having terms that are subject to variations with market forces that has not yet been accepted, if the terms become less favorable to the obligor, for example, if the price or interest rate increases, the offer could be accepted to lock in the terms such as the currently available prices or interest rates. For example, airfares can go up or down, or special travel packages can become available between a date the trip is booked and the departure date of a travel itinerary. It may be beneficial to cancel or breach the originally committed tickets and buy new tickets. Interest rates for a certificate of deposit or a mortgage can vary substantially after the contract for the CD or mortgage is finalized or before a new mortgage is closed. Hence, there exists an opportunity for cost optimization in travel itineraries and mortgages, and return optimization in the certificate of deposit investments.

To realize the cost-optimizing opportunities, consumers or obligors need to continuously monitor the market prices or interest rates before performance of the contract is required or before an offer is accepted. However, monitoring is time-consuming and cumbersome for consumers to do on a continuous basis. Therefore, it is difficult to capture a cost reduction based on fluctuations in markets prices for travel arrangements and mortgages, or the benefits of increased return in CD investments.

Therefore, a need exists for a system and method of automatic and continuous price monitoring services for contract selection and replacement.

### SUMMARY OF THE INVENTION

According to an embodiment of the present invention, a computer implemented method of selecting replacement contracts, comprises determining consumer specifications for an existing contract, monitoring a service provider maintaining specifications of a contract offer, and monitoring the specifications of the contract offer. The method further comprises identifying the contract offer as a replacement contract for the existing contract, and notifying a consumer of an identified replacement contract.

The existing contract and the replacement contract may be travel itineraries. The existing contract and the replacement contract may be mortgages. The existing contract and the replacement contract may be certificate of deposit investments.

The consumer specifications for the existing contract comprise a specification of alternative contract.

Notifying the consumer of an identified replacement contract further comprises receiving a consumer response to a notification.

The replacement contract may be a replacement itinerary. The method further comprises collecting the consumer specifications via a Web-based interface. Determining the consumer specifications further comprises requesting the consumer to specify an alternative itinerary, and receiving the alternative itinerary from the consumer with ranked choices based on preferences. The method further comprises maintaining a consumer profile describing a personalized preference. Monitoring the specifications of the contract offer further comprises maintaining a database for storing the specifications the contract offer, and updating the database upon determining a change in the specifications the contract offer. Monitoring the specifications of the contract offer further comprises fetching the specifications of the contract. Identifying the contract offer as the replacement contract for the existing contract further comprises checking the replacement contract against the existing contract, and checking the replacement contract against an alternative contract specified by the consumer. Identifying the contract offer as the replacement contract for the existing contract further comprises further comprises determining a group discount for a set of consumers classified as a group under the specifications of the contract offer. Notifying the consumer of the identified replacement contract further comprises receiving a consumer response.

The replacement contract may be one of a replacement mortgage and a replacement certificate of deposit.

According to an embodiment of the present invention, a program storage is provided device readable by machine, tangibly embodying a program of instructions executable by the machine to perform method steps for of selecting replacement contracts. The method steps comprise determining consumer specifications for an existing contract, monitoring a service provider maintaining specifications of a contract offer, and monitoring the specifications of the contract offer. The method further comprises identifying the contract offer as a replacement contract for the existing contract, and notifying a consumer of an identified replacement contract.

According to an embodiment of the present invention, a system of providing price monitoring services for contract selection and replacement, comprises a means for maintaining specifications of consumer contracts, a means monitoring new contract prices and related changes and determining a replacement contract, a means for identifying an existing contract for replacement from the specifications of consumer contracts, and a means for notifying a consumer corresponding to the existing contract of the replacement contract.

The contract may be one of a travel itinerary, a mortgage, and a certificate of deposit.

### A BRIEF DESCRIPTION OF THE DRAWINGS

Preferred embodiments of the present invention will be described below in more detail, with reference to the accompanying drawings:

FIG. 1 is an illustration of a system according to an embodiment of the present invention;

FIG. 2 is an illustration of a network according to an embodiment of the present invention;

FIG. 3 is an illustration of a system according to an embodiment of the present invention;

FIG. 4 is an illustration of a specification module according to an embodiment of the present invention;

FIG. 5 is a flow chart of a method according to an embodiment of the present invention; and

FIG. 6 is a flow chart of a method according to an embodiment of the present invention.

### DETAILED DESCRIPTION OF THE PREFERRED EMBODIMENTS

According to an embodiment of the present invention a system and method of automatic and continuous price monitoring and cost-adjusting services over a network of processors allows for contract selection and replacement. The price of a new contract may vary continuously. Exemplary contracts include, but are not limited to, travel itineraries, termed certificates of deposit, and mortgages. More specifically, according to an embodiment of the present invention, changes in prices or interest rates that may impact the costs or benefits of various contracts are monitored, and consumers are notified when reduce costs or increase benefits due to changes in the terms of an offer or contract are determined. The consumer can be advised to accept an offer, select a new contract, or replace an existing contract with a new contract. Further, the automatic monitoring of contract activities initiated by multiple different consumers can be grouped, wherein an economy of scale can be captured to reduce the costs to the individuals of the group through special packages, if offered.

Services can be applied to determine desirable contract terms for those contracts where the market prices for new contracts change. Thus, cost savings can be achieved by replacing an existing contract with a new contract, or by accepting an offer having variable terms during the period of the offer. A consumer has the flexibility of choosing a new contract that may be different from an existing contract. For example, a new travel itinerary may comprise tickets from a different airline, stipulate different travel dates, or specify that a consumer is to depart from a different airport and/or arrive at a different airport. The present invention is described with reference to three exemplary applications: travel arrangement services, mortgage services and certificate of deposit investments; however, the examples herein not are intended to be limiting. It would be obvious to one skilled in the art that other products and services can be monitored according to an embodiment of the present invention.

Travel arrangement services, provided by agents and Internet based businesses, assist consumers in arranging travel itineraries. A travel itinerary comprises, for example, bookings for airline, hotel, and rental car reservations for a business trip. For a vacation travel, it may also comprise bookings of, for example, resorts or cruise lines. Currently, when a consumer calls a travel agent or visits an Internet based travel business to arrange a trip, he/she desires to receive the best pricing available at that moment. The consumer can finalize the arrangement on the spot, accepting the best available pricing offer at the moment. Alternatively, he/she can make a reservation only, which specifies a time period for acceptance, wait for a few days, then call back to accept the terms of the reservation a different price then was available previously. In either case, the best pricing is obtained at the moment the consumer decides to accept the travel itinerary.

Depending on the business environment, competitive pressures and other factors, the travel service providers, such as the airline, hotel or car rental companies, may change their prices. If prices drop after booking an itinerary, a traveler may consider changing the itinerary to take advantage of the cost-saving opportunities. The traveler may even be willing to accepts a penalty if a final price including the penalty is lower than an original price. Alternatively, if prices rise, the traveler may consider locking in the current available low price and finalize the itinerary.

According to an embodiment of the present invention, mortgages applications, including refinancing, can also be monitored for determining a contract selection and replacement. During an application process for a mortgage or a refinance, interest rates are typically vary. The interest rate obtained by a consumer is fixed on or before a given day during the application process. Thus, mortgage consumers need to monitor the changes in the interest rate for their particular mortgage and determine what actions to take. According to an embodiment of the present invention, interest rates for mortgages can be monitored and consumer notified for beneficial variations. Even after mortgages are closed, rates can be monitored to determine whether a refinance would be beneficial to the consumer.

The certificate of deposit is another example for automatic price monitoring for optimizing contract selection and replacement. Once an investor buys a termed certificate of deposit, the return, or yield, of the CD is fixed for the duration of the term, such as 1 year or 5 years. However, when the interest rates are rising, an investor may be better off to prematurely terminate an existing CD and replace it with a new CD with a higher yield after paying a penalty in the form of reduced earning from the existing CD. To capture such an opportunity, an investor needs to monitor the interest rates. According to an embodiment of the present invention, an automatic interest rate monitoring system and method determine CD selection and replacement. Alerts can be automatically sent to the investors about the CD replacement opportunities, if they exist.

The automatic and continuous price monitoring services for optimizing contract selection and replacement can be offered by a new business enterprise, independent of the traditional service providers such as the travel arrangement services companies, mortgage companies or banks. However, because of the potential benefits to their own consumers, such automatic and continuous price monitoring services can also be offered by the traditional service providers, giving them competitive advantages. For example, a travel arrangement service company may gain market share by offering a monitoring service to its clients according to an embodiment of the present invention. More consumers will choose to do business with the company, knowing that they will realize a cost-savings should such an opportunity come about. It can also be a competitive advantage for a mortgage service company. Its consumers would not leave the company knowing that they can always be notified about the opportunities to save the interest costs for their mortgages. It is an assurance to the consumer that the monitoring is being performed on their behalf. Such an assurance can be a competitive advantage for a mortgage service company.

According to an embodiment of the present invention, a system and method comprises a means for specifying desirable terms of a contract. Alternative terms can also be provided. The system and method comprise means for a service provider to monitor market prices and special offerings, a means for the service provider to identify one or more contracts whose costs/benefits may be improved over an existing contract, a means for the service provider to notify a consumer whose contracts have been identified, and a means for the service provider to receive and process the acceptances from the notified consumers.

It is to be understood that the present invention may be implemented in various forms of hardware, software, firmware, special purpose processors, or a combination thereof. In one embodiment, the present invention may be implemented in software as an application program tangibly embodied on a program storage device. The application program may be uploaded to, and executed by, a machine comprising any suitable architecture.

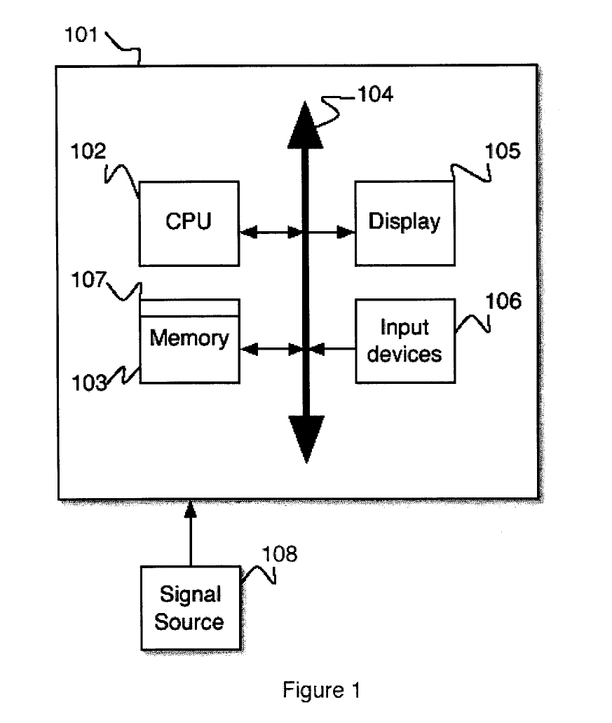

Referring to FIG. 1, according to an embodiment of the present invention, a computer system 101 for implementing the present invention can comprise, inter alia, a central processing unit (CPU) 102, a memory 103 and an input/output (I/O) interface 104. The computer system 101 is generally coupled through the I/O interface 104 to a display 105 and various input devices 106 such as a mouse and keyboard. The support circuits can include circuits such as cache, power supplies, clock circuits, and a communications bus. The memory 103 can include random access memory (RAM), read only memory (ROM), disk drive, tape drive, etc., or a combination thereof. The present invention can be implemented as a routine 107 that is stored in memory 103 and executed by the CPU 102 to process the signal from the signal source 108. As such, the computer system 101 is a general purpose computer system that becomes a specific purpose computer system when executing the routine 107 of the present invention.

The computer platform 101 also includes an operating system and micro instruction code. The various processes and functions described herein may either be part of the micro instruction code or part of the application program (or a combination thereof) which is executed via the operating system. In addition, various other peripheral devices may be connected to the computer platform such as an additional data storage device and a printing device.

It is to be further understood that, because some of the constituent system components and method steps depicted in the accompanying figures may be implemented in software, the actual connections between the system components (or the process steps) may differ depending upon the manner in which the present invention is programmed. Given the teachings of the present invention provided herein, one of ordinary skill in the related art will be able to contemplate these and similar implementations or configurations of the present invention.

In a preferred embodiment, a method and system determine automatic and continuous price monitoring services for optimizing travel itinerary selection and replacement. Those skilled in the art will appreciate that similar method and system can be designed for providing automatic price monitoring services for optimizing contract selection and replacement in general.

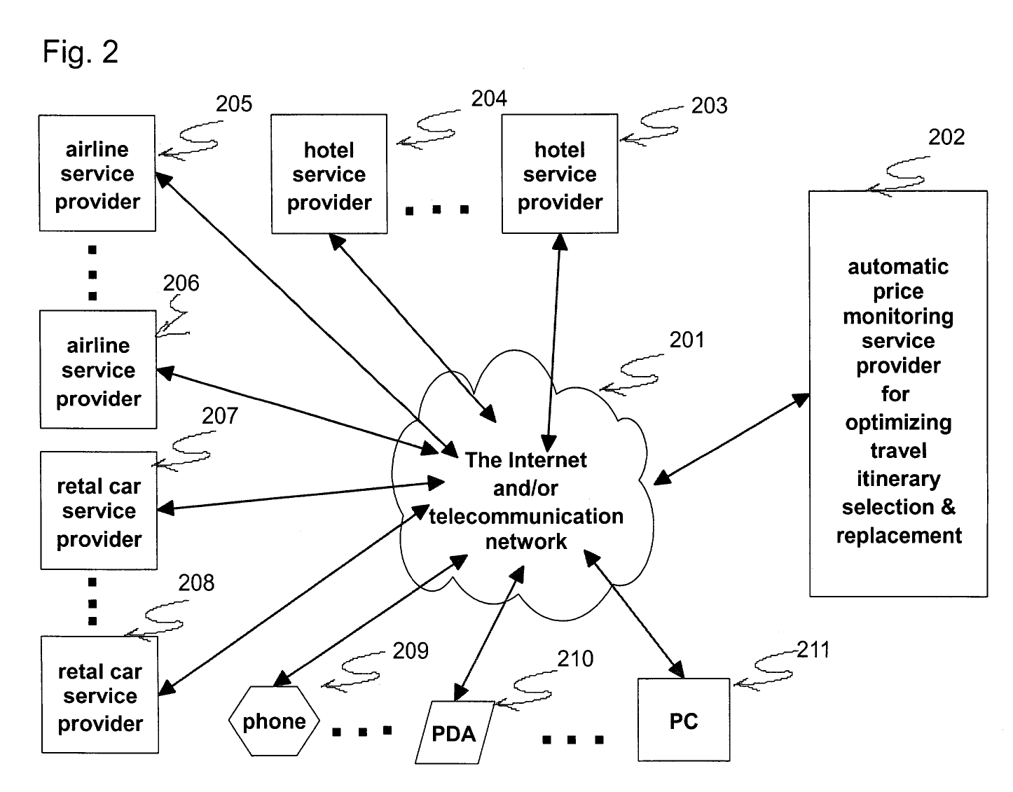

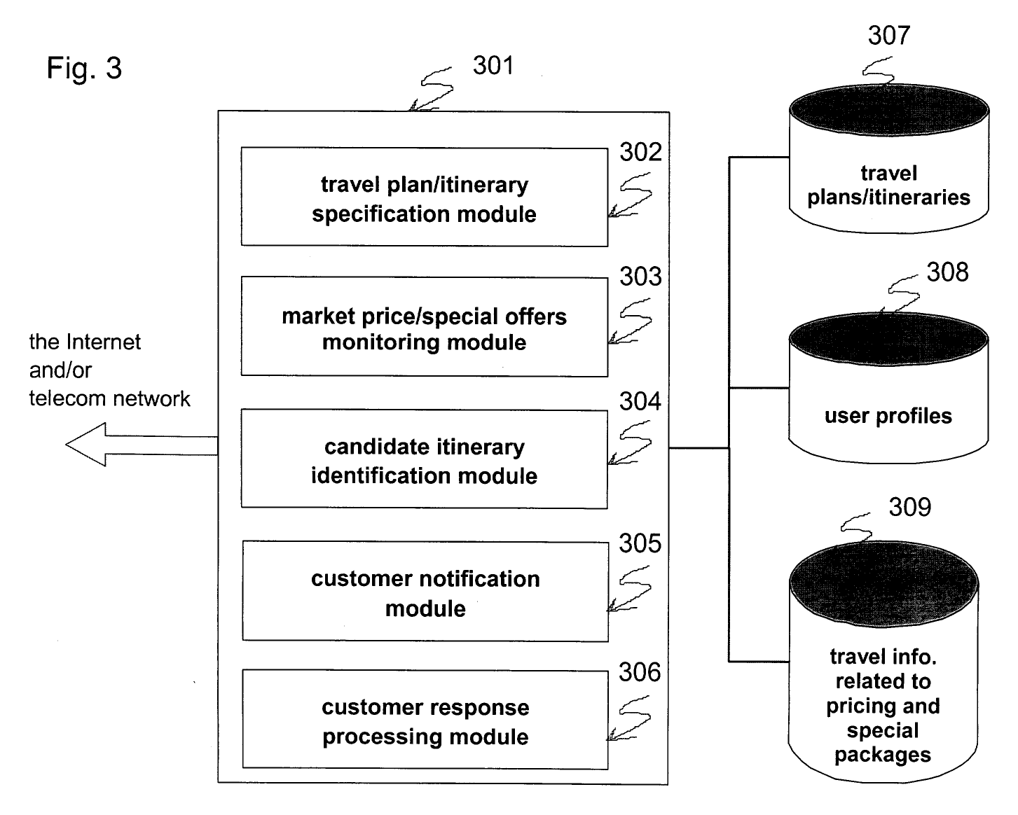

FIG. 2 is a system block diagram showing an infrastructure for providing automatic and continuous price monitoring services for optimizing travel arrangements. The automatic price monitoring service provider 202 offers its services to consumers via the Internet and/or a communications network 201. The price monitoring service provider 202 is a computer system, e.g., as shown in FIG. 3, comprising hardware and/or software. Consumers submit parameters to the price monitoring service provider 202. The parameters can be, for example, travel plan/itinerary and a personal profile. The price monitoring service provider 202 monitors and obtains updated information corresponding to the consumers parameters. For example, the price monitoring service provider 202 monitors and obtains updated information from a plurality of hotels 203-204, airlines 205-206, and rental car agencies 207-208 that meet the consumers needs as specified in the parameters. The hotels 203-204, airlines 205-206, and rental car agencies 207-208 provide network interfaces to systems providing operational information about their respective services. The operational information can include, for example, room charges and availability, air fare and seat availability, and rental car pricing and availability. The operational information is stored in a database and can be accessed via the network 201 using a user interface, such as a Web browser. With updated pricing information, the price monitoring service provider 202 identifies those travel plans/itineraries that may benefit from the updated pricing. The price monitoring service provider 202 notifies the impacted consumers by sending a notification. The notification can be sent via the network 201. The notification can be sent via other means, such as mail carrier. Consumers may receive the notification via a telephone 209, a personal digital assistant (PDA) 210, and/or a personal computer (PC) 211. After receiving the notification, consumers may or may not respond. If they do, a new itinerary can be chosen from the updated information collected by the price monitoring service provider 202 to replace a previous itinerary or a reservation can be committed to an itinerary.

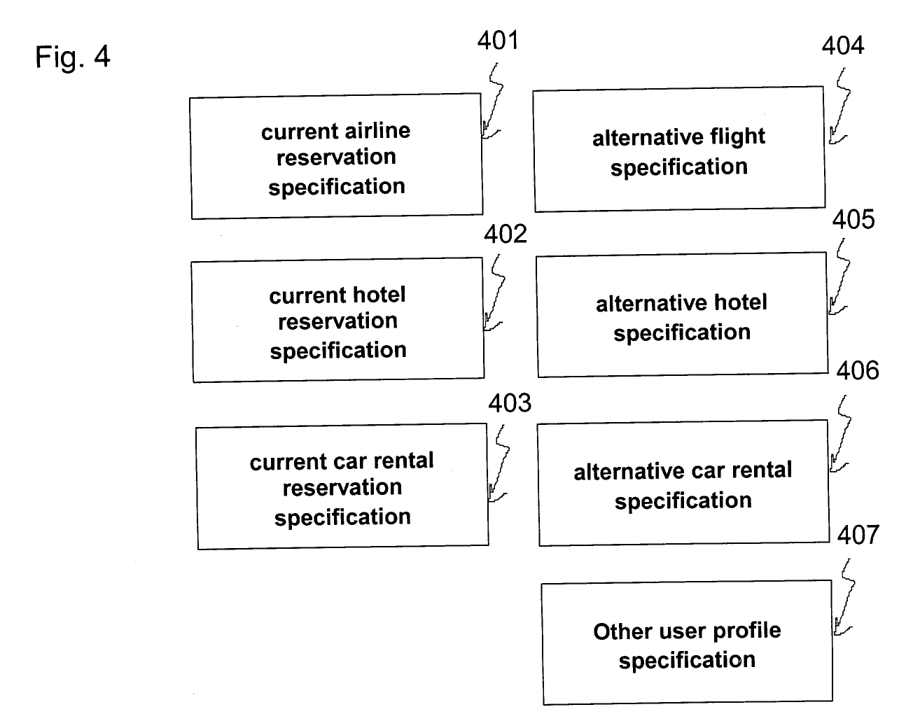

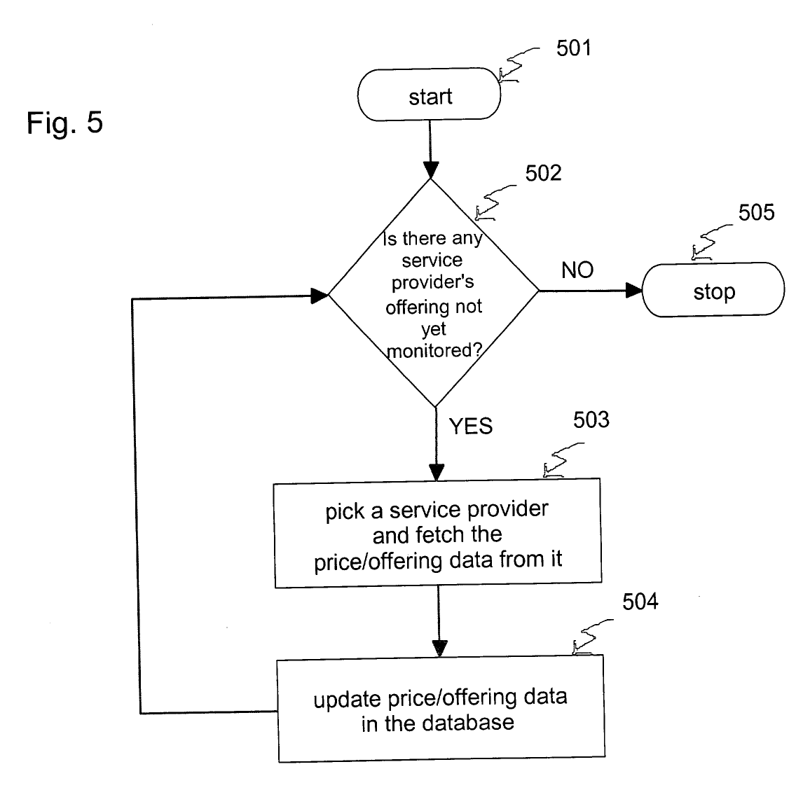

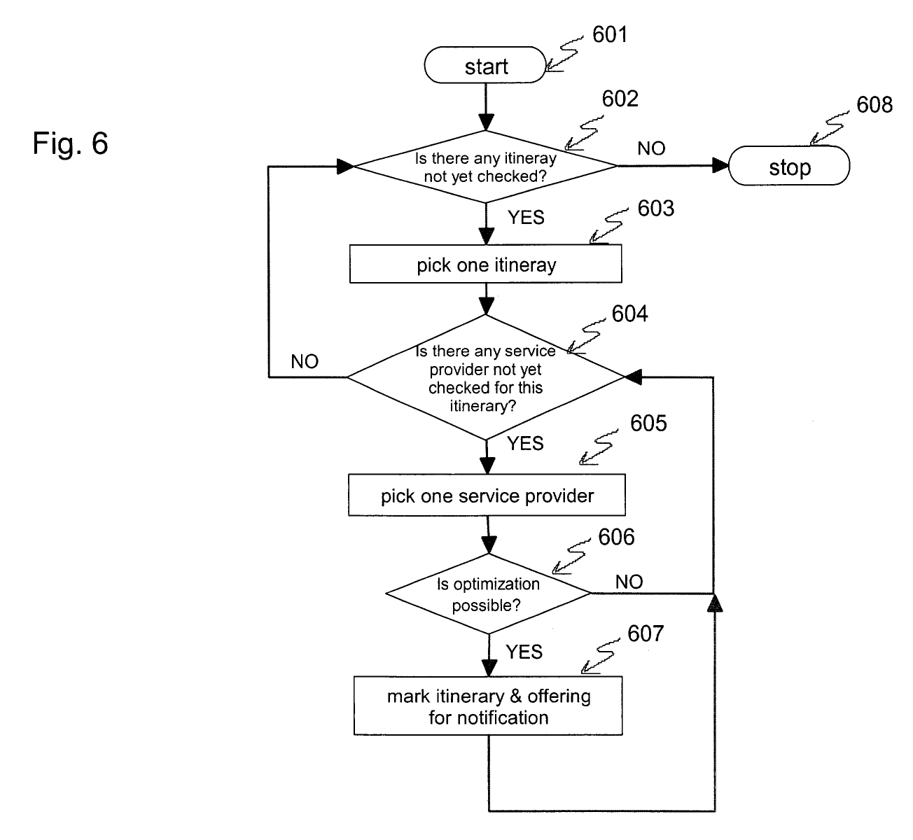

Referring to FIG. 3, a price monitoring system and a database provide automatic price monitoring services for travel arrangements. The price monitoring service comprises modules, e.g., software modules. The modules include a travel plan/itinerary specification module 302, e.g., as shown in FIG. 4, a market price/special offer monitoring module 303, e.g., as shown in FIG. 5, a candidate itinerary identification module 304, e.g., as shown in FIG. 6, a consumer notification module 305, and a consumer response processing module 306. The service provider maintains information about customers' travel itineraries and customers' alternative travel itineraries on a database 307. Information about customer's preferences are stored on a user profile database 308, and information about travel pricing and special offers are stored in a travel information database 309. The databases are maintained and used by the price monitoring service provider 202 to identify opportunities for consumers to modify their travel arrangements.

The travel plans/itinerary specification module 302 provides a GUI (graphical user interface), such as a Web-based interface, for consumers to specify travel plans/itineraries. FIG. 4 is a diagram showing GUI components for collecting consumer specifications. A consumer specifies an itinerary, including a current airline reservation 401, a current hotel reservation 402, and a current car rental reservation 403. For each of the current reservation specifications 401-403, the consumer specifies whether or not the reservation has been committed. If the reservation has been committed, the consumer specifies a penalty for canceling a particular reservation.

In FIG. 4, in addition to the current travel plans/itineraries, the consumer can specify acceptable terms for alternative flights 404, alternative hotels 405, and alternative car rentals 406. These alternative flight, hotel and car rental specifications indicate the consumer's flexibility in their travel arrangements. For example, the consumer may be willing to take a flight departing on a different time, departing from a different airport, flying a different route, or arriving at a different airport. The consumer can also specify that different hotels and different car rental companies are acceptable for this particular trip. One or more alternatives can be specified and ranked by the consumer. The reservation specifications as well as alternative specifications are stored in a database 307. The consumer also specifies other preferences 407, such as preferred seats, preferred airline companies, preferred car rental companies, and acceptable number of stops during a trip. This personalized user profile is stored in a database 308 and may be used by the price monitoring service provider 202 when it identifies potential itineraries for travel arrangement optimization 304.

The market price/special offer monitoring module 303 collects updated prices and special offers from various travel services providers, such as airlines, hotels and car rental companies. A flow chart showing a logic of the price/offer monitoring module 303 is shown in FIG. 5. The monitoring module 303 is executed periodically, such as once a day. It monitors travel service providers for updated prices and special offers, if any. When the price/offer monitoring module 303 is invoked 501, the monitoring module determines whether there is a service provider that needs to be monitored for updated prices and offerings 502. If no service provider needs to be monitored, for example, wherein updated information was previously determined from each service provider within a period for monitoring, the module stops 505. If one or more service providers is determined to need monitoring, each of the determined service providers is selected and updated prices and/or offering packages are fetched 503 from the corresponding service provider databases, e.g., 203-208. Depending on the business arrangements between the automatic price monitoring service provider 202 and the various travel service providers (e.g., airlines, hotels, and rental car companies), automatic data feeds can be set up to transmit updated pricing data from the service providers 203-208 to the price monitoring service provider 202. Alternatively, the price monitoring service provider 202 can fetch the updated data from a computer system of individual service providers. The price/offer data is updated in the corresponding database 504. The updated data is used to identify itineraries that may benefit from replacements. Upon the price monitoring module 303 determining updated pricing and special offering package information, a candidate itinerary identification module 304 is activated. FIG. 6 shows a flow chart diagram showing a logic of the candidate itinerary identification module 304. When the candidate itinerary identification module 304 is invoked 601, the candidate itinerary identification module 304 checks every itinerary against all updated prices and special offerings. In block 602, the candidate itinerary identification module 304 determines whether there is an itinerary that still needs to be examined. If no itinerary needs to be examined, then the module stops 608. Otherwise, an itinerary is selected from a set of itineraries that need to be examined 603. For each itinerary that needs to be examined, the candidate itinerary identification module 304 checks against the pricing and offering information from other service providers 604. Thus, the candidate itinerary identification module 304 selects a service provider 605 to determine a desirable itinerary 606. In identifying candidate itineraries, the current itineraries, the alternative itineraries, the penalties, and other user profile information is taken into consideration. If an opportunity is identified for a particular itinerary, then the itinerary and the identified offering are marked for user notification 607.

After identifying candidate itinerary opportunities, a consumer notification module 305 sends out notifications to the consumers whose itineraries have been identified. The notifications can be in the form of e-mails or phone mails delivered via the Internet or a telecommunications network. After receiving the notifications, the consumer can choose no action, or can choose to take advantage of the identified opportunity. If the consumer chooses to selected the identified opportunity to replace an existing itinerary, a response is sent back to the automatic and continuous price monitoring service provider 202. In this case, a consumer response processing module 306 accepts and processes the consumer's response. Contract replacement can be initiated on behalf of the consumer by the price monitoring service providers. If a contract is replaced, the customer's itinerary is updated.

Those skilled in the art will appreciate that the automatic and continuous price monitoring services can also be applied to monitoring group fare and other travel policies. For example, there are certain industry conferences where many attendees are from the same corporation, such as IBM. The price monitoring service provider can monitor the total number of corporate travelers to a certain event. If a given number of employees are attending the same event, a group fare discount may be available. In this case, cost-savings can be achieved by notifying all the participants of the fact that they can use a group discount. Without the monitoring service, it can be difficult for individuals to know about the existence of such opportunities.

Those skilled in the art will also appreciate that in return for providing automatic and continuous price monitoring services, compensation will be demanded from the consumers of such services. Different payment arrangements can be established. For example, the price monitoring service provider can demand a percentage of a customer's savings as compensation. Alternatively, the price monitoring service provider can charge a set fee for each itinerary that it maintained for a period of time. If the price monitoring service is provided as an extra service by a traditional travel arrangement company, the compensation can also be added onto the existing service fees.

Having described preferred embodiments of a system and method for monitoring prices for goods and services advertised on a network, it is noted that modifications and variations can be made by persons skilled in the art in light of the above teachings. It is therefore to be understood that changes can be made in the particular embodiments of the invention disclosed which are within the scope and spirit of the invention as defined by the appended claims. Having thus described the invention with the details and particularity required by the patent laws, what is claimed and desired protected by Letters Patent is set forth in the appended claims.

What is claimed is:

1. A computer implemented method of selecting replacement contracts, comprising:
determining consumer specifications for an existing contract;
monitoring a service provider maintaining specifications of a contract offer;
monitoring the specifications of the contract offer;
identifying the contract offer as a replacement contract for the existing contract; and
notifying a consumer of an identified replacement contract.

2. The computer implemented method of claim 1, wherein the existing contract and the replacement contract are travel itineraries.

3. The computer implemented method of claim 1, wherein the existing contract and the replacement contract are mortgages.

4. The computer implemented method of claim 1, wherein the existing contract and the replacement contract are certificate of deposit investments.

5. The computer implemented method of claim 1, wherein the consumer specifications for the existing contract comprise a specification of alternative contract.

6. The computer implemented method of claim 1, wherein notifying the consumer of an identified replacement contract further comprises receiving a consumer response to a notification.

7. The computer implemented method of claim 1, wherein the replacement contract is a replacement itinerary.

8. The computer implemented method of claim 7, further comprising collecting the consumer specifications via a Web-based interface.

9. The computer implemented method of claim 7, wherein determining the consumer specifications further comprises:
requesting the consumer to specify an alternative itinerary; and
receiving the alternative itinerary from the consumer with ranked choices based on preferences.

10. The computer implemented method of claim 7, further comprising maintaining a consumer profile describing a personalized preference.

11. The computer implemented method of claim 7, wherein monitoring the specifications of the contract offer further comprises:
maintaining a database for storing the specifications the contract offer; and
updating the database upon determining a change in the specifications the contract offer.

12. The computer implemented method of claim 7, wherein monitoring the specifications of the contract offer further comprises fetching the specifications of the contract.

13. The computer implemented method of claim 7, wherein identifying the contract offer as the replacement contract for the existing contract further comprises:
checking the replacement contract against the existing contract; and
checking the replacement contract against an alternative contract specified by the consumer.

14. The computer implemented method of claim 7, wherein identifying the contract offer as the replacement contract for the existing contract further comprises further comprises determining a group discount for a set of consumers classified as a group under the specifications of the contract offer.

15. The computer implemented method of claim 7, wherein notifying the consumer of the identified replacement contract further comprises receiving a consumer response.

16. The computer implemented method of claim 1, wherein the replacement contract is one of a replacement mortgage and a replacement certificate of deposit.

17. A program storage device readable by machine, tangibly embodying a program of instructions executable by the machine to perform method steps for of selecting replacement contracts, the method steps comprising:
determining consumer specifications for an existing contract;
monitoring a service provider maintaining specifications of a contract offer;
monitoring the specifications of the contract offer;
identifying the contract offer as a replacement contract for the existing contract; and
notifying a consumer of an identified replacement contract.

18. A system of providing price monitoring services for contract selection and replacement, comprising:
a means for maintaining specifications of consumer contracts;
a means monitoring new contract prices and related changes and determining a replacement contract;
a means for identifying an existing contract for replacement from the specifications of consumer contracts; and
a means for notifying a consumer corresponding to the existing contract of the replacement contract.

19. The system of claim 18, wherein the contract is one of a travel itinerary, a mortgage, and a certificate of deposit.
